(19) United States
(12) Patent Application Publication
(10) Pub. No.: US 2024/0008497 A1
(43) Pub. Date: Jan. 11, 2024

(54) Bun Device For Elongate Foods

(71) Applicant: Vanesa Dimitriou, Bronx, NY (US)

(72) Inventor: Vanesa Dimitriou, Bronx, NY (US)

(21) Appl. No.: 17/860,562

(22) Filed: Jul. 8, 2022

(51) Int. Cl. A21D 13/32; A21D 13/40

(52) U.S. Cl. CPC A21D 13/32; A21D 13/40

(57) ABSTRACT

A bun device for elongate foods for holding an elongate food, such as a hot dog wiener, and condiments such that the condiments are not susceptible to spilling includes a cylindrical bun elongating along a central longitudinal axis from a first end of the bun to a second end of the bun. A cavity extends longitudinally into the bun from the first end which is configured for receiving an elongate food axially through an opening defined at the first end of the bun. The bun is configured for holding the elongate food in the cavity.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to buns and more particularly pertains to a new bun for holding an elongate food, such as a hot dog wiener, and condiments such that the condiments are not susceptible to spilling.

### (2) Description of Related Art Including Information Disclosed Under 37 CFR 1.97 and 1.98

The prior art relates to buns for hot dog wieners and other elongate foods as well as buns that generally hold food within a pocket. Most of the devices in the prior art for hot dog buns disclose a variation of the traditionally known hot dog bun that cradles the hot dog wiener along an elongate surface of the wiener. Improvements on this type of bun include the provision of an oblong bowl-shaped bun intended to create more space for the contained food and a bun designed to hold a meat product comprising two cylindrical portions conjoined along an elongate surface. Another device discloses a method of creating a cylindrical hole in a traditional hot dog bun, but this device does not incorporate additional space for a condiment, nor does it disclose a cylindrical bun which may have manufacturing and aesthetic benefits.

Devices which disclose a pocketed bun do not include features which improve the bun's ability to hold onto an elongate food. In fact, these devices specifically call for shapes which are not well suited for holding elongate foods, such as a pita bread shape and a spherical shape. These devices are instead better suited to hold either planar cylindrical foods such as hamburgers, finely cut foods, or some sort of reformable filling. The prior art does not disclose a cylindrical bun for securely holding an elongate food and a condiment between the elongate food and the bun for prevention of spills.

### BRIEF SUMMARY OF THE INVENTION

An embodiment of the disclosure meets the needs presented above by generally comprising a cylindrical bun elongating along a central longitudinal axis from a first end of the bun to a second end of the bun. A cavity extends longitudinally into the bun from the first end which is configured for receiving an elongate food axially through an opening defined at the first end of the bun. The bun is configured for holding the elongate food in the cavity.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use perspective view of a bun device for elongate foods according to an embodiment of the disclosure.

FIG. 2 is an exploded perspective view of an embodiment of the disclosure.

FIG. 3 is a front view of an embodiment of the disclosure.

FIG. 4 is a cross-sectional view of an embodiment of the disclosure from arrows 4-4 in FIG. 3.

### DETAILED DESCRIPTION OF THE INVENTION

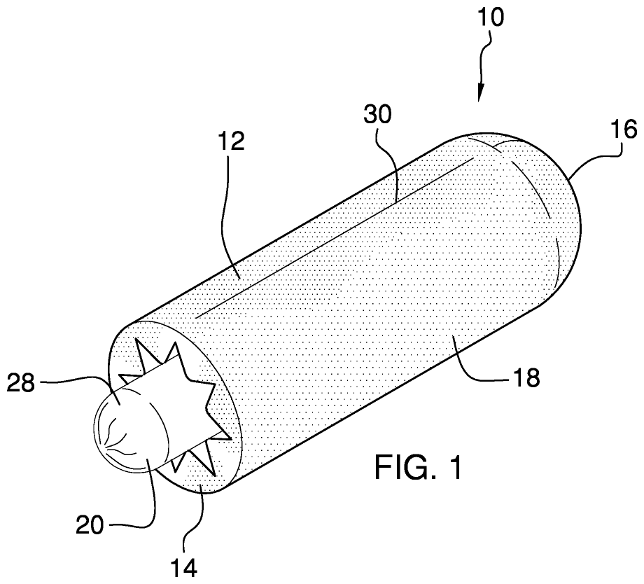

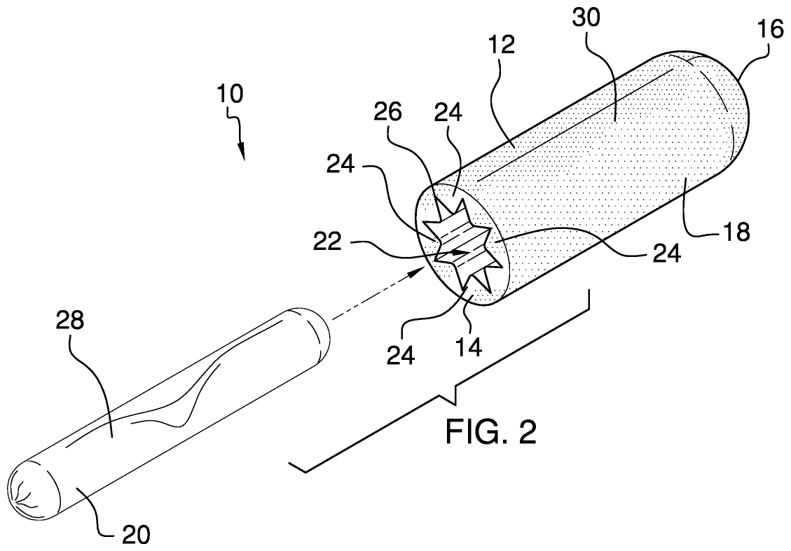

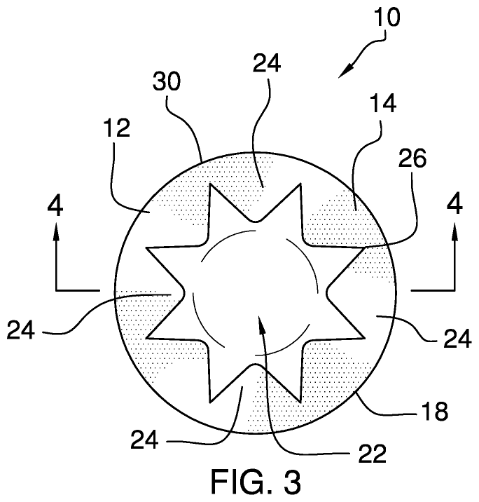

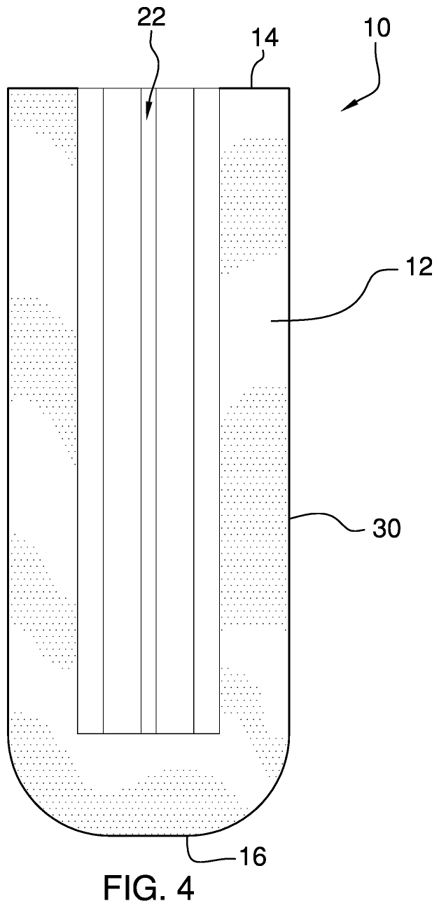

With reference now to the drawings, and in particular to FIGS. 1 through 4 thereof, a new bun embodying the principles and concepts of an embodiment of the disclosure and generally designated by the reference numeral 10 will be described.

As best illustrated in FIGS. 1 through 4, the bun device for elongate foods 10 generally comprises a cylindrical bun 12 elongating along a central longitudinal axis from a first end 14 of the bun 12 to a second end 16 of the bun 12, wherein the bun 12 has a length from the first end 14 to the second end 16 between 10.0 and 15.0 centimeters and has an outer diameter 18 between 4.0 and 6.0 centimeters. The bun 12 also has a rounded edge between a cylindrical outer surface 30 and the second end 16. A cylindrical cavity 22 extends longitudinally into the bun 12 from the first end 14 which defines an opening at the first end 14 of the bun 12. The cavity 22 is configured for receiving an elongate food 20 axially therethrough and for holding the elongate food 20 in the cavity 22. The bun 12 has a plurality of projections 24 positioned radially around and protruding from an inner surface 26 of the bun 12. Each projection 24 extends longitudinally along the inner surface 26 and has a triangular cross-section perpendicular to the central longitudinal axis. The plurality of projections 24 is configured for frictionally engaging an outer surface 28 of the elongate food 20 when the bun 12 is holding the elongate food 20, thereby securing the elongate food 20 to the bun 12. The bun 12 is configured for holding a condiment between each projection 24 and the elongate food 20. Alternatively, the cavity 22 may have a cross-section complementary in shape to a cross-section of the elongate food 20 such that an inner surface 26 of the bun 12 is configured for frictionally engaging an outer surface 28 of the elongate food 20 when the bun 12 is holding the elongate food 20, thereby securing the elongate food 20 to the bun 12.

In use, the elongate food 20 is inserted axially into the cavity 22 of the bun 12 and condiment is inserted between the elongate food 20 and the bun 12 as desired. Alternatively, the condiment may be added first, the elongate food 20 pushing the condiment into the portions of the cavity 22 between the bun 12 and the elongate food 20 when inserted.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bun device for elongate foods comprising:
a bun, said bun being cylindrical and elongating along a central longitudinal axis from a first end of said bun to a second end of said bun; and
a cavity, said cavity extending longitudinally into said bun from said first end, said bun defining only a single opening to said cavity at said first end of said bun, said second end of said bun being closed, said cavity being configured for receiving an elongate food axially therethrough, said bun being configured for holding the elongate food in said cavity;
wherein said bun has a plurality of projections protruding from an inner surface of said bun, said plurality of projections being configured for frictionally engaging an outer surface of the elongate food when said bun is holding the elongate food, thereby securing the elongate food to said bun, wherein said bun is configured for holding a condiment between each said projection and said elongate food.

2. The device of claim 1, wherein said cavity has a cross-section complementary in shape to a cross-section of the elongate food, an inner surface of said bun being configured for frictionally engaging an outer surface of the elongate food when said bun is holding the elongate food, thereby securing the elongate food to said bun.

3. (canceled)

4. The device of claim 1, wherein said plurality of projections extend longitudinally along said inner surface.

5. The device of claim 4, wherein each said projection has a triangular cross-section perpendicular to said central longitudinal axis.

6. The device of claim 1, wherein said cavity is cylindrical.

7. The device of claim 1, wherein said cavity is cylindrical, said plurality of projections being positioned radially on said inner surface of said bun.

8. The device of claim 7, wherein said plurality of projections extend longitudinally along said inner surface.

9. The device of claim 8, wherein each said projection has a triangular cross-section perpendicular to said central longitudinal axis.

10. The device of claim 1, wherein said bun has a length from said first end to said second end between 10.0 and 15.0 centimeters.

11. The device of claim 1, wherein said bun has an outer diameter between 4.0 and 6.0 centimeters.

12. A bun device for elongate foods comprising:
a bun, said bun being cylindrical and elongating along a central longitudinal axis from a first end of said bun to a second end of said bun, wherein said bun has a rounded edge between a cylindrical outer surface and said second end, wherein said bun has a length from said first end to said second end between 10.0 and 15.0 centimeters, wherein said bun has an outer diameter between 4.0 and 6.0 centimeters; and
a cavity, said cavity extending longitudinally into said bun from said first end, said bun defining only a single opening to said cavity at said first end of said bun, said second end of said bun being closed, said cavity being configured for receiving an elongate food axially therethrough, said bun being configured for holding the elongate food in said cavity;
wherein said bun has a plurality of projections protruding from an inner surface of said bun, said plurality of projections being configured for frictionally engaging an outer surface of the elongate food when said bun is holding the elongate food, thereby securing the elongate food to said bun, wherein said bun is configured for holding a condiment between each said projection and said elongate food;
wherein said plurality of projections is a set of eight projections,
wherein said plurality of projections extend longitudinally along said inner surface;
wherein each said projection has a triangular cross-section perpendicular to said central longitudinal axis; and
wherein said cavity is cylindrical, said plurality of projections being positioned radially on said inner surface of said bun.
